(19) United States
(12) Patent Application Publication
(10) Pub. No.: US 2003/0163561 A1
(43) Pub. Date: Aug. 28, 2003

(54) Environment monitoring system for monitoring environment for installing community ethernet switch

(75) Inventors: Chung-Wang Lee, Hsinchu (TW); Chih-Ken Chang, Hsinchu (TW); Pao-Ching Hu, Hsinchu (TW); Yi Liu, Hsinchu (TW)

Correspondence Address: BACON & THOMAS, PLLC, 625 SLATERS LANE, FOURTH FLOOR, ALEXANDRIA, VA, 22314

(73) Assignee: D-LINK CORPORATION, Hsinchu (TW)

(21) Appl. No.: 10/079,564

(22) Filed: Feb. 22, 2002

(51) Int. Cl. G06F 15/173; H04Q 1/30; G08B 1/08

(52) U.S. Cl. 709/224; 340/533

(57) ABSTRACT

The present invention relates to an environment monitoring system for monitoring environment for installing community Ethernet switch, which comprises an Ethernet switch installed in a panel room at a community and an environment monitoring device coupled between the Ethernet switch and a central office so that a packet transmission can be effected between the central office and a plurality of end users through the Ethernet switch and the information monitored by the environment monitoring device can be transmitted to the central office enabling the central office to monitor the panel room through the environment monitoring device and perform a real time monitoring on the environment for installing the Ethernet switch at a remote place.

### FIELD OF THE INVENTION

The present invention relates to the Internet and more particularly to an environment monitoring system for monitoring environment for installing community Ethernet switch.

### BACKGROUND OF THE INVENTION

In recent years, the Internet has been widely employed worldwide. In particular, the World Wide Web (WWW) can provide voice, graphics, and multimedia services in addition to e-mail transmission and receiving. As such, people can retrieve information from millions of sources. Further, many people take access to the Internet as a daily work. For accommodating such trend, a variety of high speed network devices have been provided by network equipment manufacturers. Such devices comprise cable modem, asymmetric digital subscriber line (ADSL) modem, etc. Moreover, various associated network peripherals are provided by network equipment manufacturers for enhancing the functionality of network. Such peripherals comprises Voice over IP (Internet Provider) device (VoIP), etc. User can employ VoIP to communicate with a remote user over the Internet for significantly reducing long distance or international telecommunication charge.

Unshielded Twisted Pair (UTP) based network structure is the most popular one of many existing network structures. A connection of the UTP based network is depicted in FIG. 1. As shown, a plurality of Ethernet Interface Cards (NICs) 30 at end users each comprises an ADSL communication interface (not shown) and a router control circuit (not shown) coupled to an Ethernet switch 32 installed in a community by an central office (or network service provider) through an existing UTP telephone line 31. Ethernet switch 32 is in turn coupled to an Ethernet equipment 34 provided by central office through a fiber-optic line 33. Ethernet equipment 34 is also coupled to the Internet 35 through fiber-optic line 33. Thus, packet signals may be sent from Ethernet NICs 30 to the Internet 35, or alternatively Ethernet NICs 30 may receive packet signals from the Internet 35. In this network structure, Ethernet switch 32 in a community installed by the central office may utilize the high speed fiber-optic line 33 to send signals to a predetermined number of end users in a typical community through the existing UTP telephone line 31. This can increase transmission rate of signals between end users and the Internet. Hence, such UTP based network structures have been widely employed in local area (e.g., community) networks. Typically, management of the network is performed in an online manner since there is a considerable distance between Ethernet switch 32 in a community and the central office, thus inhibiting an on-the-site network maintenance and management. Further, such online technique is restricted by a Simple Network Management Protocol (SNMP), thus inhibiting a real time online maintenance and management on Ethernet switch by the central office.

Typically, the Ethernet switch is installed in an electrical box. A gate of the electrical box is closed after the Ethernet switch installs. This can prevent unauthorized persons from opening the electrical box. Conventionally, the electrical box is located in a corner, sidewalk, or alley in a community. Hence, network service provider cannot monitor or maintain the Ethernet switch. Further, a number of problems may occur as follows:

(1) Setting and/or pin connection of the Ethernet switch may be incorrectly altered by an unauthorized person who opened the electrical box illegally.

(2) In the hot summer, ambient temperature of the Ethernet switch in electrical box may rise up to 50° C., while in cold winter ambient temperature may drop below 20° C. due to for example, snowstorm.

(3) In the case of disconnection of the Ethernet switch, network management engineers do not know the correct reason because it may be caused by a break of line, a temporarily loss of electricity in the Ethernet switch, or the Ethernet switch itself.

(4) Network maintenance engineers do not know whether voltage applied to the Ethernet switch is stable or not.

As stated above, SNMP is typically employed to effect a network maintenance and management by collecting information about device characteristics, packet throughput, error messages, etc. Hence, SNMP does not have the capability to provide solutions to above problems experienced by network service providers. Typically, network maintenance engineers have to go to the site of Ethernet switch for regular maintenance because the Ethernet switches are located in many different remote places. This has the drawbacks of increasing management cost, lowering network service quality, and many more. Thus improvement exists.

### SUMMARY OF THE INVENTION

The present invention is directed to an environment monitoring system for monitoring environment for installing community Ethernet switch in order to overcome the above drawbacks of prior art. The present invention comprises an Ethernet switch installed in a panel room at a community and an environment monitoring device coupled between the Ethernet switch and a central office so that a packet transmission can be effected between the central office and a plurality of end users through the Ethernet switch. Further, the central office is capable of monitoring the panel room through the environment monitoring device. Furthermore, the monitored information is transmitted to the central office. Thus, it is possible of performing a real time monitoring on the environment for installing the Ethernet switch at a remote place.

In one aspect of the present invention, the environment monitoring device comprises an electrical charge storing element. When a temporarily loss of electricity of the panel room (or power intentionally disconnected by an unauthorized person) is detected, the environment monitoring device is enabled by power supplied from electrical charge storing element. In response, a signal of the loss of electricity generated in the environment monitoring device can be sent back to central office. As such, network management engineer at central office can analyze the signal of the loss of electricity Thus, it is possible of performing a real time monitoring on the power of the Ethernet switch at a remote place.

In another aspect of the present invention, the environment monitoring device further comprises a contact switch circuit for detecting whether a normally closed gate of the panel room is opened by an unauthorized person. If such occurs a warning packet is generated immediately. The warning packet is then sent to central office. Once warning packet is received in central office, network management engineer at central office can analyze the warning packet for taking appropriate action against the illegal activity immediately.

In a further aspect of the present invention, the environment monitoring device further comprises a temperature sensing circuit for sensing a temperature of the panel room. When temperature higher or lower than the range of operating temperature is detected, a warning packet is generated immediately. The warning packet is then sent to central office for network management engineer to analyze. Thus, it is possible of performing a real time monitoring on the ambient temperature of the Ethernet switch at a remote place.

The above and other objects, features and advantages of the present invention will become apparent from the following detailed description taken with the accompanying drawings.

### BRIEF DESCRIPTION OF THE DRAWINGS

FIG. 1 schematically shows the connection of a conventional UTP based network structure;

FIG. 2 schematically shows the connection of a network structure according to the invention installed in the conventional UTP based network structure;

FIG. 3 is block diagram of environment monitoring device of FIG. 2; and

FIG. 4 is flow chart illustrating a process according to the invention.

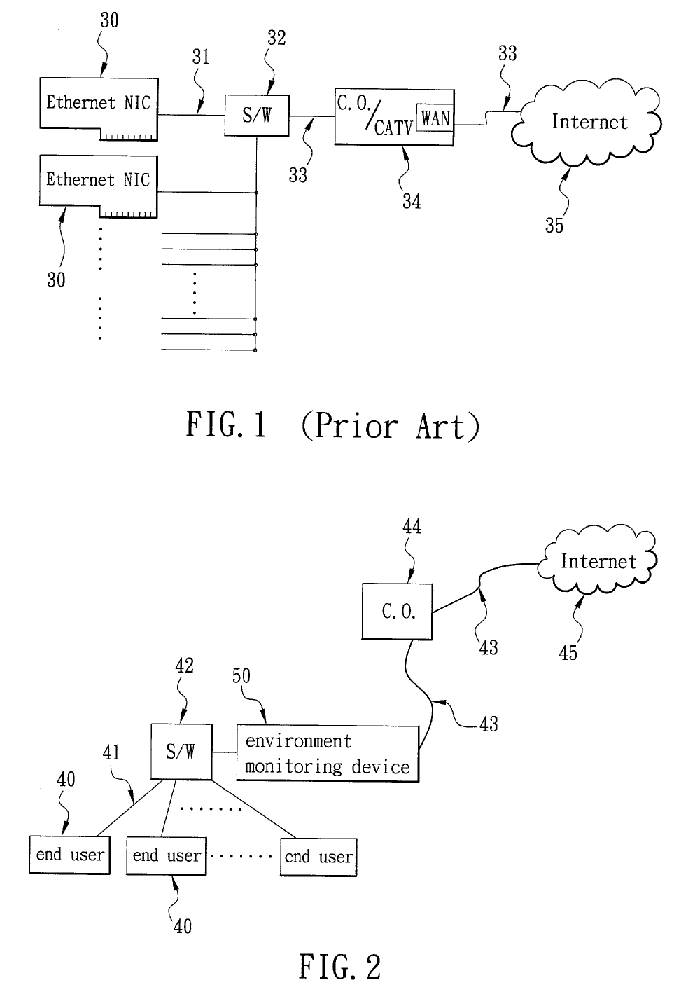

### DETAILED DESCRIPTION OF THE PREFERRED EMBODIMENTS

The present invention is directed to an environment monitoring system for monitoring environment for installing community Ethernet switch in order to overcome the above drawback of prior art, i.e., in the conventional UTP based network structure the central office is prohibited from performing a real time online maintenance and management on Ethernet switch installed in each community. In contrast, the present invention enables the central office to perform a real time online monitoring on Ethernet switch installed in each community at the prior art UTP based network structure at a remote place.

Typically, SNMP is adopted as network management application program in the existing networks. SNMP is established on a seventh layer (i.e., transmission layer) of OSI (Open System Interconnection) model. SNMP is responsible for collecting management information (e.g., device characteristics, packet throughput, error messages, etc.) from network devices. The collected management information is then stored in a Management Information Base (MIB). Finally, network management engineer performs an online management on the stored management information at MIB through SNMP. However, the collected management information does not contain information about environment monitoring, i.e., SNMP does not have the capability of monitoring environment for installing the installed network device. In the case of disconnection of a network device, network management engineers at central office do not know the correct reason of trouble through SNMP. As understood that the disconnection may be caused by, a temporarily loss of electricity, unauthorized opening of the electrical box with the network device installed therein, high temperature due to direct sunlight, or low temperature due to snowstorm. This is a serious management problem.

Referring to FIG. 2, there is shown a connection of a network structure according to the invention installed in the conventional UTP based network structure. As shown, an environment monitoring device 50 is installed in a room (e.g., panel room) at a community. One end of environment monitoring device 50 is coupled to at least one Ethernet switch 42 in the room. The other end of environment monitoring device 50 is coupled to a network management computer at central office 44 through a fiber-optic line 43. As such, Ethernet switch 42 is coupled to central office 44 via environment monitoring device 50. Also, Ethernet switch 42 is coupled to a plurality of Ethernet NICs installed in computers of a plurality of end users 40 at a community. Hence, packets may be sent from end users 40 to the central office 44, or alternatively end users 40 may receive packets from the central office 44.

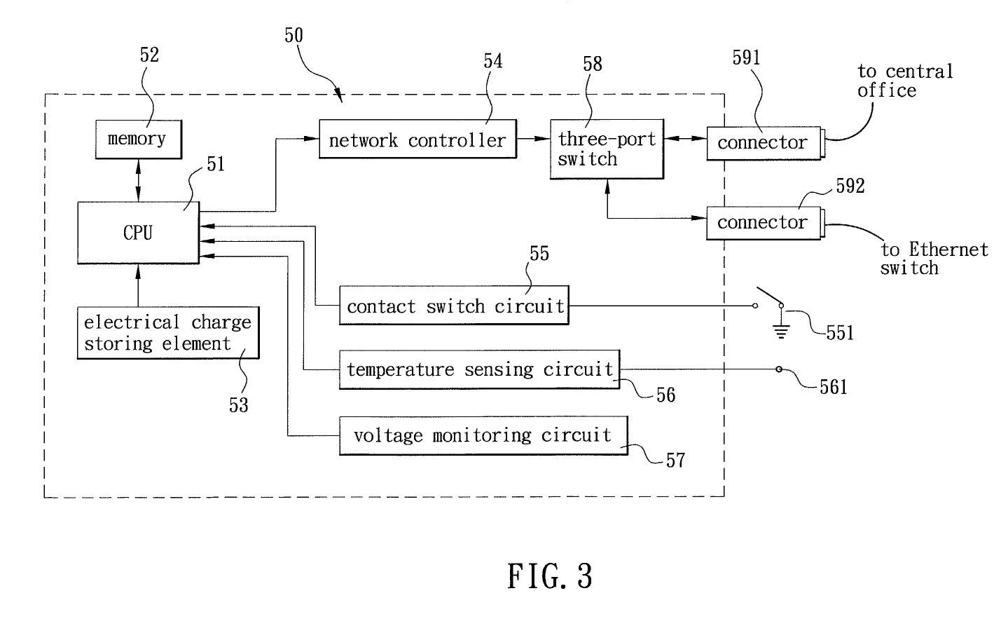

Referring to FIG. 3, environment monitoring device 50 comprises a CPU (central processing unit) 51, a memory 52, an electrical charge storing element 53, and a network controller 54. CPU 51 is coupled to memory 52, electrical charge storing element 53, and network controller 54 respectively for operating all components in environment monitoring device 50. Memory 52 is responsible for storing data and control programs required for operating environment monitoring device 50. In this embodiment, electrical charge storing element 53 is implemented as capacitor which can discharge to supply power to environment monitoring device 50 immediately after electricity of environment monitoring device 50 is temporarily lost. Hence, signal of loss of electricity can be sent back from environment monitoring device 50 to central office. Network controller 54 is responsible for outputting packet generated in environment monitoring device 50.

Referring to FIG. 3 again, in the embodiment network controller 54 is coupled to three-port switch 58 which is in turn coupled to connectors 591 and 592 respectively. As such, network controller 54 is coupled to central office 44 and Ethernet switch 42 via connectors 591 and 592 respectively. Thus, central office 44 is capable of transmitting packets to Ethernet switch 42 and receiving the same therefrom both through three-port switch 58. Environment monitoring device 50 further comprises a contact switch circuit 55 having one end coupled to CPU 51 and the other end (i.e., detection end) 551 coupled to gate (not shown) of a room (e.g., panel room) wherein the gate is normally closed. In a case that an unauthorized person opens electrical box illegally contact switch circuit 55 is enabled to generate a signal which is in turn sent to CPU 51. In response, CPU 51 commands network controller 54 to generate a warning packet which is in turn sent to central office 44. Once warning packet is received in central office 44, network management engineer at central office 44 can analyze the warning packet for taking appropriate action against the illegal activity immediately.

Referring to FIG. 3 again, in the embodiment environment monitoring device 50 further comprises a voltage monitoring circuit 57 having one end coupled to CPU 51 and the other end coupled to power terminal (not shown) of environment monitoring device 50. Hence, sensed voltage value at the power terminal can be regularly sent to CPU 51 through voltage monitoring circuit 57. In response, CPU 51 commands network controller 54 to generate a voltage packet which is in turn sent to central office 44. Once voltage packet is received in central office 44, network management engineer at central office 44 can monitor the power of environment monitoring device 50. When any irregularity (e.g., unstable voltage) is detected, network management engineer can inform maintenance engineers to go to the site of Ethernet switch for repair immediately. When a temporarily loss of electricity is detected by voltage monitoring circuit 57 CPU 51 will be informed immediately to cause the electrical charge storing element 53 to discharge. Hence, CPU 51 is enabled by power supplied from electrical charge storing element 53. In response, at least one signal of the loss of electricity generated in CPU 51 can be sent back to central office 44. As such, network management engineer at central office 44 can inform maintenance engineers to go to the site of Ethernet switch for repair immediately.

Referring to FIG. 3 again, in the embodiment environment monitoring device 50 further comprises a temperature sensing circuit 56 having one end coupled to CPU 51 and the other end coupled to a temperature sensor 561 which is exposed in the room (e.g., panel room) so that temperature data sensed by temperature sensor 561 is sent to CPU 51 through temperature sensing circuit 56. In response, CPU 51 commands network controller 54 to generate a temperature packet which is in turn sent to central office 44. Once warning packet is received in central office 44, network management engineer at central office 44 can monitor the temperature of the room (e.g., panel room). When any irregularity (e.g., temperature higher or lower than the range of operating temperature) is detected, network management engineer can inform maintenance engineers to go to the site of Ethernet switch for repair immediately.

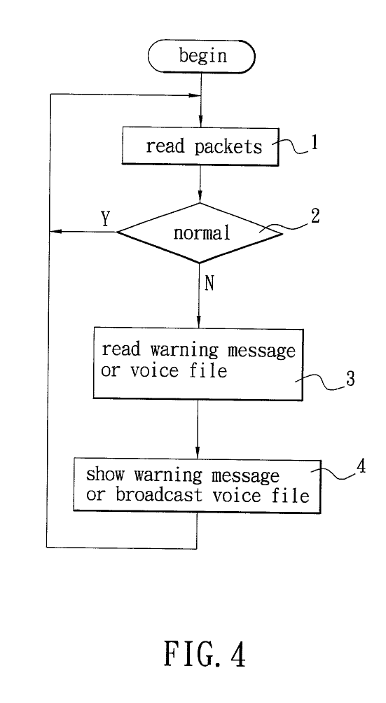

FIG. 4 is flow chart illustrating a process according to the invention. A network management application program installed in central office 44 is responsible for collecting about warning, voltage, and temperature packets over the Internet. The collected packets are then stored in MIB. Hence, network management computer at central office 44 is capable of performing the following steps with respect to the packets stored in MIB:

First, read a packet stored in a field of MIB (step 1). Then a determination is made whether the read packet is normal or not (step 2). If yes, the process goes back to step 1 to read a packet in an immediately next field of MIB. Otherwise, the process jumps to step 3. In step 3, read a stored warning message or voice file stored in a memory of network management computer at central office 44 based on contents (or type) of the packet. Finally, the warning message is shown on screen of the computer or the voice file is broadcast through speaker of the computer for prompting network management engineer at central office 44 to take appropriate action in response (step 4).

While the invention has been described by means of specific embodiments, numerous modifications and variations could be made thereto by those skilled in the art without departing from the scope and spirit of the invention set forth in the claims.

What is claimed is:

1. An environment monitoring system for monitoring environment for installing community Ethernet switch comprising:
an environment monitoring device installed in a room at a community, the environment monitoring device having one end coupled to a remote central office through a fiber-optic line; and
at least one Ethernet switch installed in the room, the Ethernet switch having one end coupled to the other end of the environment monitoring device so as to connect to the central office through the environment monitoring device, and the other ends coupled to existing telephone lines which are in turn coupled to a plurality of end users so that packets from the end users are capable of transmitting to the central office or vice versa;
wherein when the environment monitoring device detects an irregularity in the room at least one warning packet is generated, and the warning packet is sent to the central office for a network management engineer at the central office to analyze so as to remotely perform a real time monitoring on the environment for installing the Ethernet switch.

2. The environment monitoring system of claim 1, wherein the environment monitoring device comprises:
a memory for storing data and control programs required for operating the environment monitoring device;
an electrical charge storing element for supplying power to the environment monitoring device while electricity of the environment monitoring device is temporarily lost so that a signal of the loss of electricity is operative to send back from the environment monitoring device to the central office;
a network controller for outputting the packet generated in the environment monitoring device; and
a CPU (central processing unit) coupled to the memory, the electrical charge storing element, and the network controller respectively for operating all components in the environment monitoring device.

3. The environment monitoring system of claim 2, wherein the electrical charge storing element is a capacitor.

4. The environment monitoring system of claim 2, wherein the environment monitoring device further comprises:
a three-port switch coupled to the network controller; and
two connectors coupled to the three-port switch respectively so that the network controller is coupled to the central office and the Ethernet switch via the connectors respectively, and the central office is capable of transmitting the packets to the Ethernet switch and receiving the same therefrom both through the three-port switch.

5. The environment monitoring system of claim 2, wherein the environment monitoring device further comprises:
a contact switch circuit having one end coupled to the CPU and the other detection end coupled to a normally closed gate of the room wherein an unauthorized opening of the gate causes the contact switch circuit to generate a signal which is in turn sent to the CPU for commanding the network controller to generate a warning packet prior to sending to the central office.

6. The environment monitoring system of claim 2, wherein the environment monitoring device further comprises:
a voltage monitoring circuit having one end coupled to the CPU and the other end coupled to a power terminal of the environment monitoring device wherein a sensed voltage value at the power terminal is regularly sent to the CPU through the voltage monitoring circuit for commanding the network controller to generate a voltage packet which is in turn sent to the central office.

7. The environment monitoring system of claim 6, wherein when the loss of electricity is detected at the voltage monitoring circuit, the CPU is informed immediately to cause the electrical charge storing element to discharge so that the CPU is enabled by power supplied from the electrical charge storing element, and in response at least one signal of the loss of electricity generated in the CPU is sent back to the central office.

8. The environment monitoring system of claim 2, wherein the environment monitoring device further comprises:
a temperature sensor which is exposed in the room; and
a temperature sensing circuit having one end coupled to the CPU and the other end coupled to the temperature sensor so that temperature data sensed by the temperature sensor is sent to the CPU through the temperature sensing circuit, and in response the CPU commands the network controller to generate a temperature packet which is in turn sent to the central office.

9. The environment monitoring system of claim 1, further comprising a network management application program in the central office for collecting about the warning, the voltage, and the temperature packets over the Internet wherein the collected packets are stored in a MIB (management information base) for the central office performing an analysis with respect to the packets so that when the irregularity occurs a warning message or a voice file stored in a memory of the central office is read for showing or broadcasting.
